(19) United States
(12) Patent Application Publication
(10) Pub. No.: US 2007/0210106 A1
(43) Pub. Date: Sep. 13, 2007

(54) Trigger Sprayer with Piston Rod and Spring Tamper Evident Connection

(75) Inventor: Donald D. Foster, St. Charles, MO (US)

Correspondence Address: THOMPSON COBURN, LLP, ONE US BANK PLAZA, SUITE 3500, ST LOUIS, MO, 63101, US

(73) Assignee: CONTINENTALAFA DISPENSING COMPANY, St. Peters, MO (US)

(21) Appl. No.: 11/615,219

(22) Filed: Dec. 22, 2006

Related U.S. Application Data
(63) Continuation-in-part of application No. 11/369,351, filed on Mar. 7, 2006.

(51) Int. Cl. B67B 5/00; B65D 88/54; B67D 5/40

(52) U.S. Cl. 222/153.06; 222/383.1; 222/340

(57) ABSTRACT

A manually operated trigger sprayer includes U-shaped springs that bias the trigger sprayer trigger away from the trigger sprayer pump chamber, where the U-shaped springs are connected to a piston rod by tamper evident connections. When the trigger of the trigger sprayer is manually operated, the tamper evident connections between the spring and piston rod break, indicating that the trigger sprayer has been operated.

### CROSS-REFERENCE TO RELATED APPLICATIONS

This is a continuation-in-part of patent application Ser. No. 11/369,351, filed on Mar. 7, 2006, and currently pending.

### BACKGROUND OF THE INVENTION

1. Field of the Invention

The present invention pertains to the construction of a manually operated trigger sprayer in which a U-shaped spring is connected to a piston rod by tamper evident connections. When the trigger of the trigger sprayer is manually operated, the tamper evident connections between the spring and piston rod are broken, indicating that the trigger sprayer has been operated.

2. Description of the Related Art

Handheld and hand pumped liquid dispensers commonly known as trigger sprayers are used to dispense many household products and commercial cleaners. Trigger sprayers have been used to dispense household cleaning or cooking liquids and have been designed to selectively dispense the liquids in a spray, stream, or foaming discharge. The trigger sprayer is typically connected to a plastic bottle that contains the liquid dispensed by the sprayer.

A typical trigger sprayer includes a sprayer housing that is connected to the neck of the bottle by either a thread connection or a bayonet-type connection. The sprayer housing is formed with a pump chamber and a vent chamber, a liquid supply passage that communicates the pump chamber with a liquid inlet opening of the sprayer housing, and a liquid discharge passage that communicates the pump chamber with a liquid outlet opening of the sprayer housing. A dip tube is connected to the sprayer housing liquid inlet opening to communicate the pump chamber with the liquid contents of the bottle connected to the trigger sprayer.

A nozzle assembly is connected to the sprayer housing at the liquid outlet opening. Some nozzle assemblies include a nozzle cap that is rotatable relative to the sprayer housing between an “off” position where liquid discharge from the trigger sprayer is prevented, and one or more “on” positions where liquid discharge from the trigger sprayer is permitted. In addition, known nozzle assemblies can affect the liquid discharged by the trigger sprayer to discharge the liquid in a spray pattern, in a stream pattern, or as a foam.

A pump piston is mounted in the sprayer housing pump chamber for reciprocating movement between charge and discharge positions of the piston relative to the pump chamber. When the pump piston is moved to its charge position, the piston is retracted out of the pump chamber. This creates a vacuum in the pump chamber that draws liquid from the bottle, through the dip tube and into the pump chamber. When the pump piston is moved to its discharge position, the piston is moved into the pump chamber. This exerts a force on the liquid in the pump chamber that pumps the liquid from the pump chamber, through the liquid discharge passage of the sprayer housing and out of the trigger sprayer through the nozzle assembly.

A trigger is mounted on the sprayer housing for movement of the trigger relative to the housing. The trigger is operatively connected to the pump piston to cause the reciprocating movement of the pump piston in the pump chamber in response to movement of the trigger. A user's hand squeezes the trigger toward the sprayer housing to move the trigger and move the pump piston toward the discharge position of the piston in the pump chamber. A spring operatively connected to the pump piston and the sprayer housing pushes the piston back to the discharge position of the piston relative to the pump chamber when the user's squeezing force on the trigger is released.

Inlet and outlet check valves are assembled into the respective liquid supply passage and liquid discharge passage of the trigger sprayer. The check valves control the flow of liquid from the bottle interior volume through the liquid supply passage and into the pump chamber, and then from the pump chamber and through the liquid discharge passage to the nozzle assembly of the trigger sprayer.

Manually operated trigger sprayers of the type described above are typically offered to consumers for purchase with the trigger sprayer attached to a liquid container. The trigger sprayer and container typically are not enclosed in packaging. Therefore, the trigger of the trigger sprayer is accessible when the trigger sprayer and attached liquid container are displayed on a store shelf. This presents the possibility of the trigger sprayer being operated, and a portion of the liquid in the bottle attached to the trigger sprayer being dispensed from the bottle. This would result in the consumer that purchases the previously operated trigger sprayer receiving a lesser amount of the liquid product in the bottle than would be expected by the consumer. Any doubts of a consumer that a trigger sprayer was possibly previously operated and therefore the attached bottle did not contain as much liquid product as expected could be overcome if the trigger sprayer was provided with some type of tamper evident mechanism that would indicate to the consumer that the trigger sprayer had not previously been operated.

### SUMMARY OF THE INVENTION

The trigger sprayer of the present invention achieves the desired objective of providing a visual indicator to a consumer of whether or not the trigger sprayer had been previously operated.

The trigger sprayer of the invention has a sprayer housing construction that is similar to that of prior art trigger sprayers. The sprayer housing basically includes an integral cap that attaches to the neck of a separate bottle that contains the liquid to be dispensed by the trigger sprayer. A liquid inlet opening is provided on the sprayer housing inside the cap, and a liquid supply passage extends upwardly through the sprayer housing from the liquid inlet opening.

The sprayer housing also includes a pump chamber having a cylindrical pump chamber wall. The pump chamber communicates with the liquid supply passage.

A liquid discharge passage extends through a liquid discharge tube on the sprayer housing. The liquid discharge passage communicates the pump chamber with a liquid outlet opening on the sprayer housing.

A valve assembly is inserted into the liquid supply passage and separates the liquid supply passage from the liquid discharge passage. The valve assembly includes an input valve that controls the flow of liquid from the sprayer housing inlet opening to the pump chamber, and an output valve that controls the flow of liquid from the pump chamber and through the liquid discharge passage to the liquid outlet opening.

A valve plug assembly is assembled into the liquid supply passage of the sprayer housing. The valve plug assembly includes a valve seat that seats against the input valve, and a vent baffle that defines a vent air flow path through the pump chamber to the interior of the bottle attached to the trigger sprayer.

A nozzle assembly is assembled to the trigger sprayer at the sprayer housing liquid outlet opening. The nozzle assembly is rotatable relative to the trigger sprayer to close the liquid flow path through the liquid discharge passage and the liquid outlet opening, and to open the liquid flow path through the liquid discharge passage and the outlet opening. The nozzle assembly has several open positions relative to the sprayer housing that enable the selective discharge of a liquid in a stream pattern, a spray pattern, and a foaming discharge.

A piston assembly is mounted in the pump chamber for reciprocating movements between charge and discharge positions of the piston assembly relative to the sprayer housing. The piston assembly includes a pump piston and a vent piston, both mounted in the pump chamber. As the pump piston moves to its charge position, the vent piston is moved to a closed position where a venting air flow path through the pump chamber and through the venting air baffle is closed. As the pump piston is moved to its discharge position, the vent piston is moved to an open position in the pump chamber. This opens the venting air flow path through the pump chamber and the venting air baffle to the interior volume of the bottle attached to the trigger sprayer.

A manually operated trigger is mounted on the sprayer housing for pivoting movement. The trigger is engaged by the fingers of a user's hand holding the trigger sprayer. Squeezing the trigger causes the trigger to move toward the pump chamber, and releasing the squeezing force on the trigger allows the trigger to move away from the pump chamber.

A piston rod is operatively connected between the trigger and the pump piston. The piston rod has a length with opposite first and second ends, with the first end engaging with the trigger and the second end being connected to the piston assembly. The piston rod has a cylindrical portion at the second end that is connected to the piston assembly.

A pair of springs are mounted on the sprayer housing outside of the pump chamber. The pair of springs are formed integrally with a spring ring that is mounted on the exterior surface of the pump chamber. The pair of springs extend in U-shaped configurations from the spring ring, over opposite sides of the piston rod to distal ends of the springs positioned adjacent the first end of the piston rod. The distal ends of the springs engage with the first end of the piston rod, and thereby the springs bias the piston rod and the connected piston assembly to the charge position of the piston assembly relative to the sprayer housing. In one embodiment, the proximal ends of the springs are connected to the piston rod at the rod first end. In a second embodiment, the proximal ends of the springs engage with, but are separate from the piston rod.

The U-shaped configurations of the springs bias the piston rod and the piston assembly away from the pump chamber. This biases the piston assembly toward its charge position relative to the pump chamber and the sprayer housing. By manually squeezing the trigger of the trigger sprayer, the proximal ends of the springs are moved toward the distal ends of the springs, narrowing the U-shaped configurations of the springs. When the squeezing force on the trigger is removed, the resiliency of the springs pushes the trigger away from the pump chamber and moves the pump piston back to its charge position relative to the pump chamber.

A plurality of tamper evident connections extend from the exterior surface of the piston rod to the circular collar or ring that attaches the springs to the forward end of the pump chamber wall. The tamper evident connections are provided by a plurality of slender ribs or spokes that radiate outwardly from the exterior of the piston rod to the ring. The ribs or spokes are spacially arranged around the circumference of the piston rod and around the circumference of the ring. The cross-section dimension of each rib is sufficiently small that, when the trigger is manually squeezed to push the piston rod into the forward end of the pump chamber, each of the plurality of ribs breaks, allowing the piston rod to move into the pump chamber. The breaking of the plurality of ribs provides a tamper evident indication to the potential purchaser of the trigger sprayer that the trigger sprayer has been previously operated.

### DESCRIPTION OF THE DRAWING FIGURES

Further features of the invention are set forth in the following detailed description of the preferred embodiment of the invention and in the drawing figures.

FIG. 1 is a side sectioned view of the trigger sprayer of the invention with the trigger in a forward position relative to the sprayer housing.

FIG. 2 is a perspective view of the disassembled component parts of the trigger sprayer.

FIG. 3 is a top view of the trigger sprayer with the shroud removed.

FIG. 4 is a side sectioned view of the trigger sprayer along the line 4-4 of FIG. 3 and with the trigger in a rearward position relative to the sprayer housing.

FIG. 5 is a perspective view of a further embodiment of the piston rod and springs of the invention.

FIG. 6 is a perspective view of a further embodiment of the piston rod and springs of the invention.

### DETAILED DESCRIPTION OF THE PREFERRED EMBODIMENT

As stated earlier, the novel design of the trigger sprayer of the present invention provides a tamper evident feature to the trigger sprayer. This tamper evident feature is clearly visible to the potential consumer of the trigger sprayer, providing the consumer with an indication on whether or not the trigger sprayer has been previously operated. The tamper evident feature is added to the trigger sprayer without significantly altering the construction of the trigger sprayer component parts.

Several component parts of the trigger sprayer are found in the typical construction of a trigger sprayer, and therefore these component parts are described only generally herein. It should be understood that although the component parts are shown in the drawing figures and are described as having a certain construction, other equivalent constructions of the component parts are known. These other equivalent constructions of trigger sprayer component parts are equally well suited for use with the novel features of the invention to be described herein.

The trigger sprayer includes a sprayer housing 12 that is formed integrally with a connector cap 14. The connector cap 14 removably attaches the trigger sprayer to the neck of a bottle containing the liquid to be dispensed by the trigger sprayer. The connector cap 14 shown in the drawing figures has a bayonet-type connector on its interior. Other types of equivalent connectors may be employed in attaching the trigger sprayer to a bottle. A liquid inlet opening 16 is provided on the sprayer housing 12 in the interior of the connector cap 14. The inlet opening 16 provides access to a liquid supply passage 18 that extends upwardly through a cylindrical liquid column 22 formed in the sprayer housing 12. The column 22 has a center axis 24 that is also the center axis of the liquid supply passage 18. An air vent opening 26 is also provided on the sprayer housing 12 in the interior of the connector cap 14. A cylindrical sealing rim 28 projects outwardly from the connector cap interior and extends around the liquid inlet opening 16 and the vent opening 26. The rim 28 engages inside the neck of a bottle connected to the trigger sprayer to seal the connection.

The sprayer housing includes a pump chamber 32 contained inside a cylindrical pump chamber wall 34 on the sprayer housing 12. The pump chamber cylindrical wall 34 has a center axis 36 that is perpendicular to the liquid supply passage center axis 24. The interior surface of the pump chamber wall 34 has a smaller interior diameter section adjacent a rear wall 38 of the pump chamber, and a larger interior diameter section adjacent an end opening 42 of the pump chamber. The smaller interior diameter portion of the pump chamber 32 functions as the liquid pump chamber, and the larger interior diameter portion of the pump chamber 32 functions as a portion of a venting air flow path through the sprayer housing 12. The vent opening 26 in the sprayer housing connector cap 14 communicates the interior of the larger interior diameter portion of the pump chamber 32 with a bottle connected to the trigger sprayer. A pair of openings 46, 48 pass through the pump chamber rear wall 38 and communicate the interior of the pump chamber with the liquid supply passage 18. The first of the openings 46 is the liquid input opening to the pump chamber 32, and the second of the openings 48 is the liquid output opening from the pump chamber.

A liquid discharge tube 52 is also formed on the sprayer housing 12. The liquid discharge tube is cylindrical and has a center axis 54 that is parallel with the pump chamber center axis 36. The liquid discharge tube 52 defines the liquid discharge passage 58 of the sprayer housing. One end of the liquid discharge passage 58 communicates with the liquid supply passage 18 in the liquid column 22, and the opposite end of the liquid discharge passage 58 exits the sprayer housing 12 through a liquid outlet opening 62 on the sprayer housing.

The sprayer housing 12 is also formed with a pair of exterior side walls or side panels 64 that extend over opposite sides of the pump chamber wall 34 and over opposite sides of the discharge tube 54. The side walls 64 extend over the pump chamber wall 34 in the area of the pump chamber rear wall 38, but do not extend in the forward direction the full extent of the pump chamber wall 34 to the end opening 42. The side walls 64 are spaced outwardly from the pump chamber wall 34 and the discharge tube 54 forming voids 66 between the side wall 64 and the pump chamber wall 34 and the discharge tube 54. The side walls 64 have lengths on the opposite sides of the liquid discharge tube 54 that extend substantially the entire length of the discharge tube. Rear walls 68 of the sprayer housing 12 extend outwardly from opposite sides of the liquid column 22 and connect to the rearward edges of the side walls 64.

A valve assembly comprising an intermediate plug 72, a resilient sleeve valve 74 and a resilient disk valve 76 is assembled into the liquid supply passage 18. The valve assembly is inserted through the liquid inlet opening 16 and the valve assembly plug 72 seats tightly in the liquid supply passage 18 between the pump chamber input opening 46 and the pump chamber output opening 48. Thus, the plug 72 separates the liquid inlet opening 16 into the pump chamber 32 from the liquid outlet opening 62 from the pump chamber 32. The disk valve 76 is positioned in the liquid supply passage 18 to control the flow of liquid from the liquid inlet opening 16 into the pump chamber 32, and to prevent the reverse flow of liquid. The sleeve valve 74 is positioned to control the flow of liquid from the pump chamber 32 and through the liquid discharge passage 58 and the liquid outlet opening 62, and to prevent the reverse flow of liquid.

A valve plug assembly comprising a valve seat 78, a dip tube connector 82, and an air vent baffle 84 is assembled into the liquid inlet opening 16 inside the connector cap 14. The valve seat 78 is cylindrical and seats against the outer perimeter of the valve assembly disk valve 76. A hollow interior bore of the valve seat 78 allows liquid to flow through the bore and unseat the disk valve 76 from the seat 78 as the liquid flows from the inlet opening 16 to the pump chamber 32. The periphery of the disk valve 76 seats against the valve seat 78 to prevent the reverse flow of liquid. The dip tube connector 82 is a cylindrical connector at the center of the plug assembly that connects to a separate dip tube (not shown). The valve plug assembly positions the dip tube connector 82 so that it is centered in the connector cap 14 of the sprayer housing. The air vent baffle 84 covers over but is spaced from the vent opening 26 in the connector cap 14. The baffle 84 has a baffle opening 86 that is not aligned with the vent opening 26, but communicates with the vent opening through the spacing between the air vent baffle 84 and the interior surface of the connector cap 14. This allows air to pass through the vent opening 26 and through the baffle spacing and the baffle opening 86 to vent the interior of the bottle connected to the trigger sprayer to the exterior environment of the sprayer. Because the vent opening 26 and baffle opening 86 are not directly aligned, the air vent baffle 84 prevents liquid in the bottle from inadvertently passing through the baffle opening 86, the baffle spacing and the vent opening 26 to the exterior of the trigger sprayer should the trigger sprayer and bottle be inverted or positioned on their sides.

A nozzle assembly 92 is assembled to the sprayer housing 12 at the liquid outlet opening 62. The nozzle assembly 92 can have the construction of any conventional known nozzle assembly that produces the desired discharge pattern of liquid from the trigger sprayer. In the preferred embodiment of the invention, the nozzle assembly 92 has a rotatable nozzle cap 94 that selectively changes the discharge from a “off” condition where the discharge is prevented, to a “spray” condition, a “stream” condition and/or a foaming discharge.

A piston assembly comprising a liquid pump piston 102 and a vent piston 104 is mounted in the pump chamber 32 for reciprocating movement along the pump chamber axis 36. The pump piston 102 reciprocates between a charge position and a discharge position in the pump chamber 32. In the charge position, the pump piston 102 moves in a forward direction away from the pump chamber rear wall 38. This expands the interior of the pump chamber creating a vacuum in the chamber that draws liquid into the pump chamber, as is conventional. In the discharge position, the pump piston 102 moves in an opposite rearward direction into the pump chamber toward the pump chamber rear wall 38. This compresses the liquid drawn into the pump chamber 32 and forces the liquid through the output opening 48, past the sleeve valve 74 and through the liquid discharge passage 58 and the liquid outlet opening 62. As the pump piston 102 reciprocates in the pump chamber 32 between the charge and discharge positions, the vent piston 104 reciprocates between a vent closed position where the vent piston 102 engages against the interior surface of the pump chamber wall 34, and a vent open position where the vent piston 104 is spaced inwardly from the interior of the pump chamber wall 34. In the vent open position of the vent piston 104, air from the exterior environment of the sprayer can pass through the pump chamber opening 42, past the vent piston 104 to the vent opening 26, and then through the spacing between the baffle 84 and the connector cap 14, through the vent baffle opening 86 and to the interior of the bottle connected to the trigger sprayer.

A manually operated trigger 112 is mounted on the sprayer housing 12 for movement of the trigger relative to the sprayer housing. The trigger 112 has a pair of pivot posts 114 that project from opposite sides of the trigger and mount the trigger to the sprayer housing 12 for pivoting movement. A pair of abutments 116 project outwardly from the pivot posts 114 and limit the pivoting movement of the trigger 112 toward the sprayer housing 12. The construction of the trigger includes a finger engagement surface that is engaged by the fingers of a user's hand. Squeezing the trigger causes the trigger to pivot rearwardly toward the pump chamber 32, and releasing the squeezing force on the trigger allows the trigger to pivot forwardly away from the pump chamber.

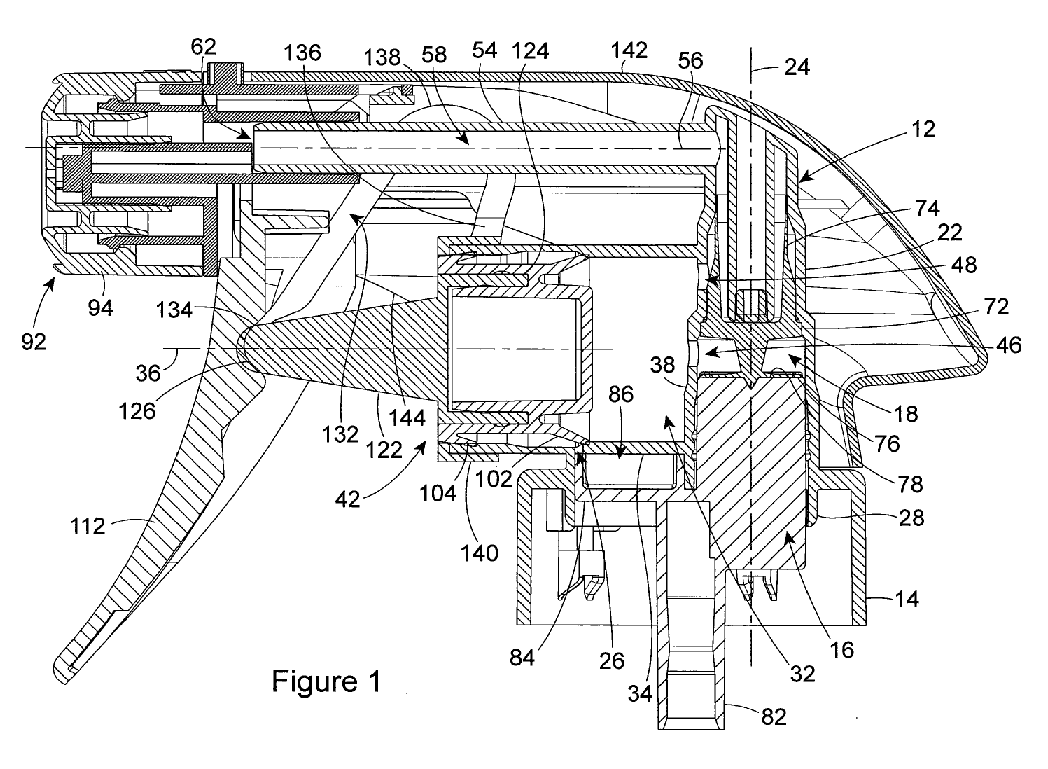

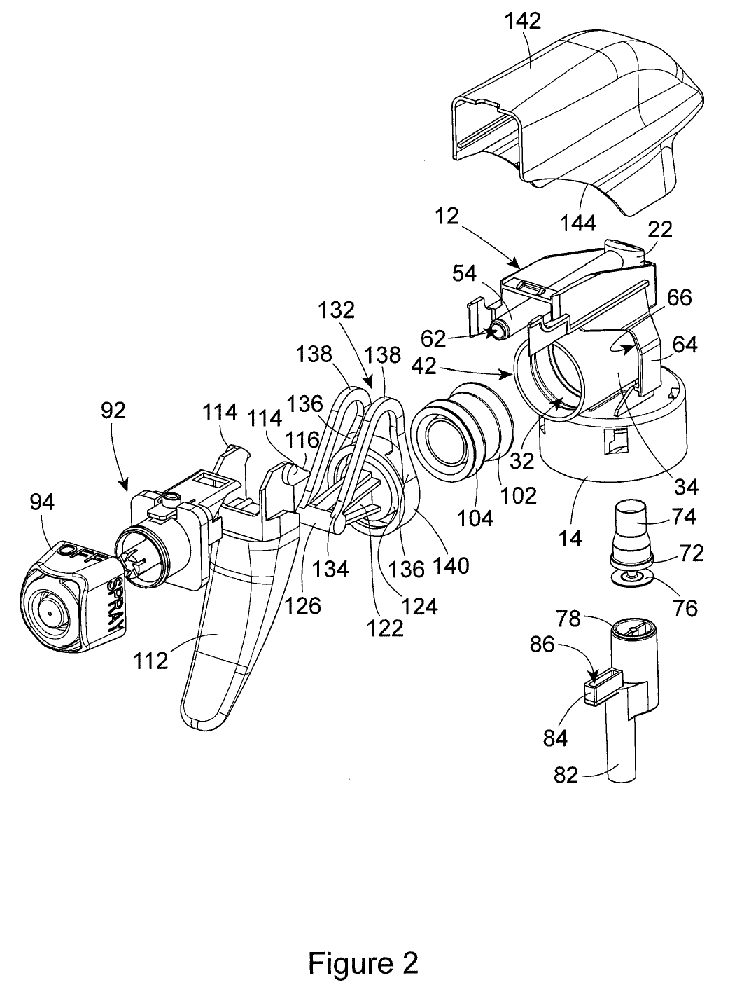

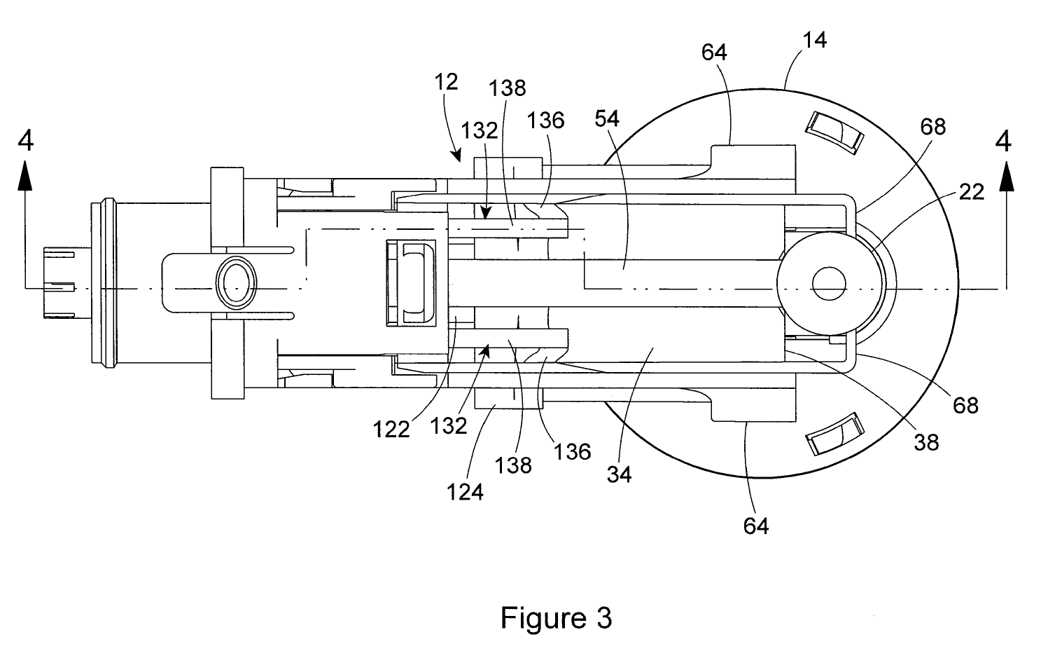

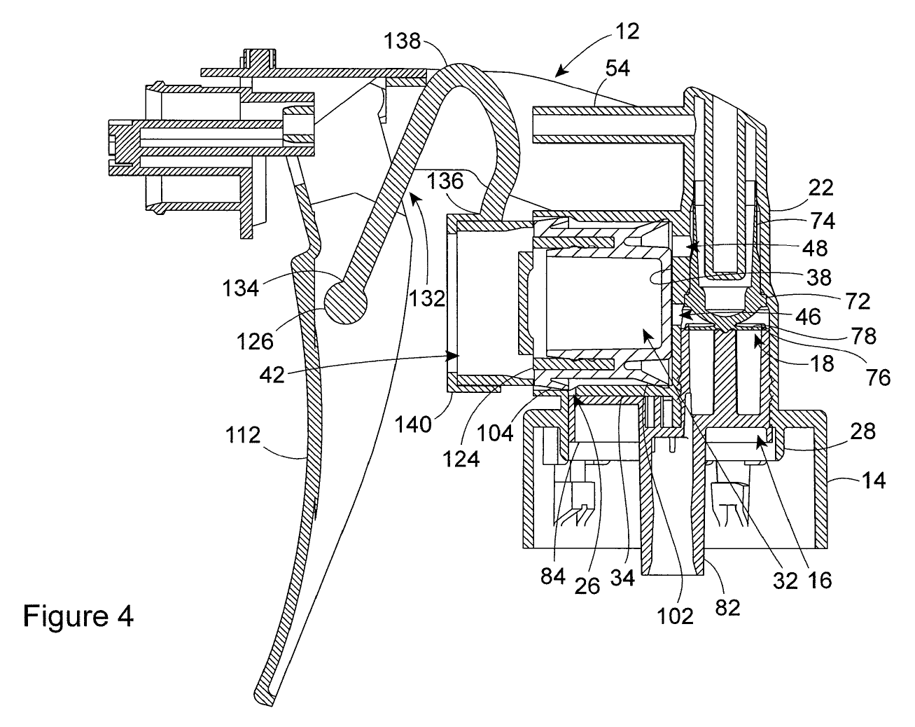

The trigger sprayer of FIGS. 1-4 includes a piston rod 122 that is operatively connected between the trigger 112 and the pump piston 102 and vent piston 104. The piston rod 122 has a length with a annular collar or ring 124 at one end of the rod length. The ring 124 is assembled to the piston assembly pump piston 102 and vent piston 104. The opposite end 126 of the piston rod 122 engages with and is operatively connected to the trigger 112.

The construction of the trigger sprayer also includes a pair of springs 132 that are formed integrally with the piston rod 122 and the ring 124. Together the springs 132, the piston rod 122, and the ring 124 are one, monolithic piece of plastic material, thereby reducing the number of separate component parts that go into the construction of the trigger sprayer. The pair of springs 132 each have a narrow, elongate length that extends between opposite proximal 134 and distal 136 ends of the springs. The intermediate portions 138 of the springs between the proximal ends 134 and distal ends 136 have the same bent or inverted U-shaped configurations. The spring proximal ends 134 are connected to the piston rod 122 at the first end or forward end 126 of the piston rod. From the proximal ends 134, the lengths of the springs angle upwardly away from the piston rod 22 and the pump chamber center axis 36 and then extend through the intermediate portions 138 of the springs. As the lengths of the springs extend through their U-shaped intermediate portions 138, the springs extend along opposite sides of the liquid discharge tube 54 and over the pump chamber wall 34. The springs then extend downwardly toward the pump chamber center axis 36 as the springs extend to their distal ends 136. The spring distal ends 136 are integrally connected to a circular collar or ring 140. The ring 140 is attached around the pump chamber 32 at the end opening 42 and thereby connects the spring distal ends 136 to the sprayer housing 12.

The inverted, U-shaped configurations of the springs 132 bias the piston rod 122 and the connected pump piston 102 and vent piston 104 outwardly away from the pump chamber rear wall 38. This biases the pump piston 102 toward its charge position relative to the pump chamber 32 and the sprayer housing 12. By manually squeezing the trigger 112, the spring proximal ends 134 move toward the spring distal ends 136, narrowing the U-shaped bend in the intermediate portions 138 of the springs. When the squeezing force on the trigger 112 is removed, the resiliency of the springs pushes the trigger 112 away from the pump chamber rear wall 38 and moves the pump piston 102 back to its charge position relative to the pump chamber 32.

A shroud 142 is attached over the sprayer housing 12 to provide an aesthetically pleasing appearance to the trigger sprayer. The shroud 142 has a lower edge 144 that is positioned below the U-shaped bends in the pair of springs 132. Thus, the shroud 142 protects the springs 132 from contact with portions of the hand or other objects exterior to the trigger sprayer when the trigger sprayer is being operated.

By providing the U-shaped springs 132 as an integral part of the pump piston rod 122 in lieu of the conventional coiled metal spring positioned in the pump chamber, the component parts of the trigger sprayer are reduced. This results in reduced manufacturing costs for the trigger sprayer.

In addition, by providing the pair of springs 132 as an integral part of the pump piston rod 122 and the ring 140, the springs are constructed of the same piece of material as the pump piston rod and ring. This eliminates the need for a separate metal coil spring and enables all of the component parts of the trigger sprayer to be constructed of a plastic material. With all the sprayer parts being constructed of plastic, the trigger sprayer can be recycled more economically after use.

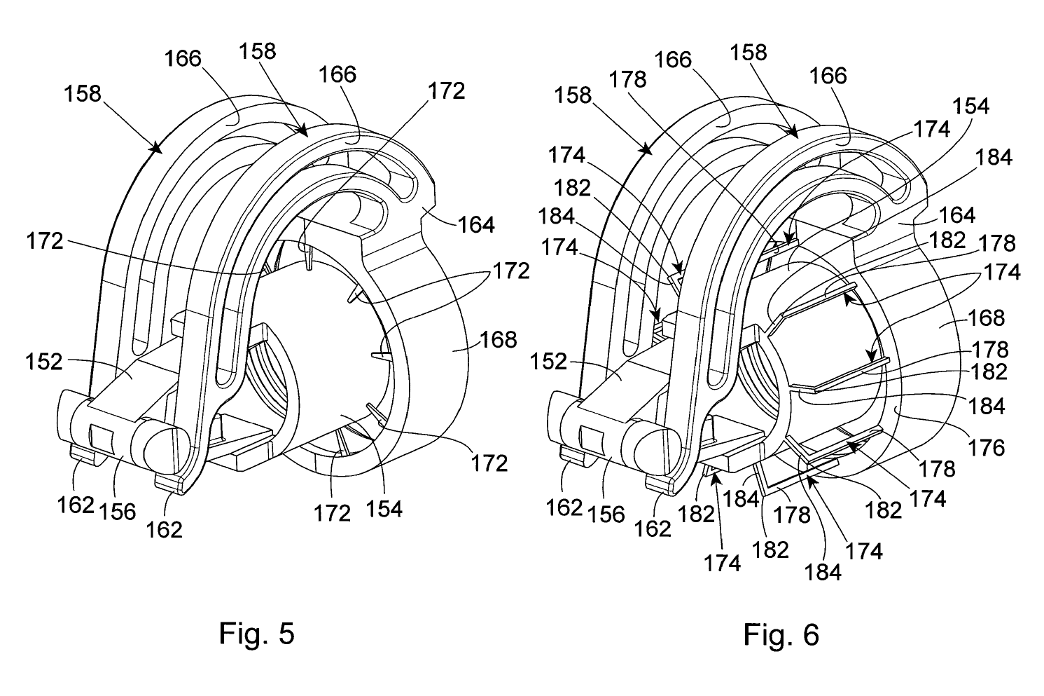

FIG. 5 shows a variant embodiment of the piston rod and springs of the previously described embodiment of FIGS. 1-4. In the embodiment of FIG. 5, the piston rod 152 is also designed for an operative connection between the trigger 112 and the pump piston 102 and vent piston 104 of the trigger sprayer shown in FIGS. 1-4. The piston rod 152 has a length with an annular collar or ring 154 at one end of the rod length. This ring 154 is assembled to the piston assembly pump piston 102 and the vent piston 104 in the same manner as shown in FIGS. 1-4. The opposite end 156 of the piston rod 152 engages with and is operatively connected to the trigger 112 in the same manner as shown in FIGS. 1-4.

A pair of springs 158 are formed integrally with the piston rod 152 in a similar manner to the previous embodiment of the piston rod and springs. The springs 158 each have a narrow, elongate length that extends between opposite proximal 162 and distal 164 ends of the springs. The intermediate portions 166 of the springs differ from that of the first described embodiment of the springs in that they are formed as a pair of separate, curved spring portions as shown in FIG. 5. The pair of intermediate portions 166 of the springs have basically the same bent or inverted U-shaped configurations between the spring proximal ends 162 and distal ends 164 as shown in the embodiment of the springs in FIGS. 1-4. The spring proximal ends 162 are separate from, but engage with the piston rod proximal end 156. The spring distal ends 164 are integrally connected to a circular collar or ring 168. The ring 168 is dimensioned to be attached around the pump chamber 32 in the same manner as the previously described spring of FIGS. 1-4.

The piston rod 152 and springs 158 of FIG. 5 differ from that of FIGS. 1-4 in that a plurality of tamper evident connections 172 are integrally connected between the piston rod ring 154 and the spring ring 168. The tamper evident connections 172 are formed as a plurality of narrow spokes or ribs that extend radially from the exterior surface of the piston rod ring 154 to the interior surface of the spring ring 168. As shown in FIG. 5, the ribs 172 are spaced axially forward of the back end of the piston rod ring 154 to allow for the attachment of the piston rod ring 154 to the pump piston 102 and vent piston 104. The radially outer ends of the ribs 172 are connected to the forward edge of the spring ring 168 to allow for the attachment of the spring ring 168 on the pump chamber 32. The tamper evident ribs 172 are dimensioned sufficiently thin so that, when the trigger 112 is manually manipulated and the piston rod 152 is pushed into the pump chamber 32, the ribs 172 will all break away from their connections between the piston rod ring 154 and the spring ring 168. The broken ribs 172 function as an indicator that the trigger sprayer has been operated, and in this way function as a tamper evident indicator for the trigger sprayer.

FIG. 6 shows an embodiment of the piston rod 152, the springs 158, and the spring ring 168 that is substantially the same as that of FIG. 5, except for the positioning of the tamper evident connections 174. In FIG. 6, the tamper evident connections 174 are narrow ribs integrally connected at their radially outer ends to a forward facing surface 176 of the spring ring 168. Portions 178 of the tamper evident ribs 174 extend axially forward from the spring ring 168 to corners 182 of the tamper evident ribs 174. From the corners 182, portions of the tamper evident ribs 184 extend radially inwardly to integral connections with the forward end of the piston rod ring 154.

The tamper evident ribs 174 shown in FIG. 6 function in substantially the same manner as those of FIG. 5. As the trigger 112 is manually squeezed toward the trigger sprayer housing and the piston rod 152 moves into the pump chamber 32, each of the tamper evident ribs 174 breaks. The breaking of the tamper evident ribs 174 provides a visual indication that the trigger sprayer has been operated, and thereby provides evidence that the trigger sprayer has been tampered with.

Although the trigger sprayer of the invention has been described above by reference to a specific embodiment, it should be understood that modifications and variations could be made to the trigger sprayer without departing from the intended scope of the following claims.

1) A manually operated trigger sprayer comprising:
a sprayer housing having a pump chamber in the sprayer housing, a liquid inlet opening on the sprayer housing, a liquid supply passage extending through the sprayer housing communicating the liquid inlet opening with the pump chamber, a liquid outlet opening on the sprayer housing, and a liquid discharge passage extending through the sprayer housing communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing;
a piston rod projecting from the pump piston and engaging with the trigger; and,
a narrow breakable rib having a length with opposite first and second ends, the rib first end being connected to the piston rod and the rib second end being connected to the pump chamber.

2) The trigger sprayer of claim 1, further comprising:
the rib extending outside of the pump chamber between the piston rod and the pump chamber.

3) The trigger sprayer of claim 2, further comprising:
the rib and the piston rod being one monolithic piece of material.

4) The trigger sprayer of claim 2, further comprising:
the rib being one of a plurality of narrow breakable ribs having lengths with opposite first and second ends, with the rib lengths being outside the pump chamber and with the rib first ends connected to the piston rod and the rib second ends connected to the pump chamber.

5) The trigger sprayer of claim 4, further comprising:
the piston rod and the plurality of ribs being one monolithic piece of material.

6) The trigger sprayer of claim 4, further comprising:
the plurality of ribs being spacially positioned around the piston rod and the lengths of the ribs extending outwardly from the rib first ends to the rib second ends connected to the pump chamber.

7) The trigger sprayer of claim 6, further comprising:
a ring connected to the second ends of the plurality of ribs, the ring being attached to the pump chamber and thereby connecting the plurality of ribs to the pump chamber.

8) The trigger sprayer of claim 6, further comprising:
each of the ribs having an angled length.

9) The trigger sprayer of claim 2, further comprising:
a ring connected to the rib second end, the ring being attached to the pump chamber and thereby connecting the rib second end to the pump chamber.

10) The trigger sprayer of claim 9, further comprising:
the rib and the ring being one monolithic piece of material.

11) The trigger sprayer of claim 1, further comprising:
the pump chamber having a center axis that defines mutually perpendicular axial and radial directions,
the length of the rib extending radially from the rib first end and away from the piston rod, then through a bend in the rib length, and then axially along the piston rod to the rib second end connected to the pump chamber.

12) The trigger sprayer of claim 11, further comprising:
a ring connected to the rib second end, the ring being attached to the pump chamber and thereby connecting the rib second end to the pump chamber.

13) The trigger sprayer of claim 11, further comprising:
the rib being one of a plurality of ribs spacially positioned around the piston rod.

14) The trigger sprayer of claim 13, further comprising:
a ring connected to the second ends of the plurality of ribs, the ring being attached to the pump chamber and thereby connecting the plurality of ribs to the pump chamber.

15) A manually operated trigger sprayer comprising:
a sprayer housing having a pump chamber in the sprayer housing, a liquid inlet opening on the sprayer housing, a liquid supply passage extending through the sprayer housing communicating the liquid inlet opening with the pump chamber, a liquid outlet opening on the sprayer housing, and a liquid discharge passage extending through the sprayer housing communicating the liquid outlet opening with the pump chamber;
a pump piston mounted in the pump chamber for reciprocating movement between charge and discharge positions of the pump piston in the pump chamber;
a trigger mounted on the sprayer housing for movement of the trigger relative to the sprayer housing;
a piston rod projecting from the pump piston to the trigger; and,
a breakable rib outside the pump chamber, the rib having a length with opposite first and second ends, the rib first end being connected to the piston rod and the rib second end being connected to a collar that is attached to the pump chamber.

16) The trigger sprayer of claim 15, further comprising:
the piston rod, the rib and the collar being one monolithic piece of material.

17) The trigger sprayer of claim 15, further comprising:
the collar being a circular ring attached around the pump chamber.

18) The trigger sprayer of claim 15, further comprising:
the length of the rib extending outwardly away from the rib first end and away from the piston rod, and to the rib second end connected to the collar.

19) The trigger sprayer of claim 15, further comprising:
the length of the rib extending outwardly away from the rib first end and away from the piston rod to a bend in the rib, and then extending away from the bend along the piston rod to the rib second end connected to the collar.

20) The trigger sprayer of claim 15, further comprising:
the rib being one of a plurality of ribs outside the pump chamber and having lengths with opposite first and second ends, the first ends being connected to the piston rod and the second ends being connected to the collar.

21) The trigger sprayer of claim 20, further comprising:
the piston rod, the plurality of ribs and the collar being one monolithic piece of material.

22) The trigger sprayer of claim 20, further comprising:
the plurality of ribs being spacially positioned around the piston rod and the lengths of the ribs extending away from the rib first ends and away from the piston rod, and to the rib second ends connected to the collar.

23) The trigger sprayer of claim 22, further comprising:
the lengths of the ribs extending away from the rib first ends to bends in the ribs, and then extending from the bends along the piston rod to the rib second ends connected to the collar.
